(19) United States
(12) Patent Application Publication
(10) Pub. No.: US 2014/0161950 A1
(43) Pub. Date: Jun. 12, 2014

(54) Processing Quinoa for Improved Protein-to-Carbohydrate Formulations

(71) Applicants: Laurice Anne-Marie Pouvreau, Bennekom (NL); Marja Willemien Kanning, Wageningen (NL); Freddie Van de Velde, Klingelbeek (NL)

(72) Inventors: Laurice Anne-Marie Pouvreau, Bennekom (NL); Marja Willemien Kanning, Wageningen (NL); Freddie Van de Velde, Klingelbeek (NL)

(21) Appl. No.: 13/566,391

(22) Filed: Aug. 3, 2012

Related U.S. Application Data
(60) Provisional application No. 61/514,942, filed on Aug. 4, 2011.

(51) Int. Cl. A23L 1/10

(52) U.S. Cl. CPC A23L 1/1041
USPC 426/481

(57) ABSTRACT

Methods for processing Quinoa or other seed that includes soaking the seeds in an aqueous system having alkaline agents, and/or coating the seed with lipases, proteases and/or esterase enzyme preparation to reduce saponin content. After the Quinoa seed is ground, it may be steeped in water that is treated with enzymes or a series of combinations of enzymes. The water is then heated further and sparged or rinsed with hot water. The resulting liquid wort is then separated from the washed grains for further processing and potential combination with other base liquids. Milled seeds may also undergo pH adjustment as well as a separation of protein from starches (carbohydrates) and other material. The proteins and starches may be concentrated to increase protein-to-carbohydrate ratios in the end food product. Starches may also be hydrolyzed prior to concentration in order to improve protein-to-carbohydrate ratios.

The present application claims priority to U.S. Provisional Patent Application Ser. No. 61/514,942 filed on Aug. 4, 2011, which is herein incorporated by reference in its entirety.

### TECHNICAL FIELD

The present invention relates to the preparation and processing of Quinoa for use in food products. More specifically, the disclosure is directed to methods for preparing Quinoa seeds for use in beverage products, and for creating Quinoa-based formulations having improved protein-to-carbohydrate formulations.

### BACKGROUND INFOMATION

Quinoa (Chenopodium Quinoa) is a pseudocereal native to South America. In recent years, there has been considerable interest in Quinoa because of its unique and interesting properties. Its starch exists as very small granules and is low in amylose, which is known to be less digestible to humans. The protein content and quality of Quinoa, which has an amino acid profile similar to that of casein, is high compared to true cereals. Quinoa is rarely allergenic because of the absence of gluten. Hence, it can be used in foods designed to reduce allergies in sensitive individuals, such as celiac disease patients, and it seems ideal for specialty foods such as infant formulae.

The outer layer of Quinoa seeds are naturally known to have an outside coating containing saponins (between 0.01% to 4.5% concentration). It is theorized that saponins protect the seed against attack by birds, insects and other pests. However, saponins taste bitter, foam in water and have certain toxic properties that may damage intestinal mucosal cells. With regard to food product applications, saponins are generally considered antinutritional compounds that distract from the utility of Quinoa.

Saponins are water- and methanol-soluble, detergent-like molecules that consist of hydrophilic sugar chains attached to lipophilic triterpenoid aglycones. The saponins in Quinoa are generally derivatives of three main triterpenes or sterols termed sapogenins: phytoaccagenic acid, hederagenin and oleanolic acid. Traditionally, saponins are removed by washing the seed in cold water or aqueous alkali, followed by a scrubbing of the seeds or by abrasive dehulling. A combination of abrasive milling and washing is often used as well. Despite these techniques, an improved method is needed for processing Quinoa, particularly for use in food products and beverages. Furthermore, existing processes for producing food products such as milk from Quinoa have insufficient extraction yields and are not particularly suited for acceptable protein retention. As such, there is a need for processes for producing Quinoa food products having improved extraction yields and higher protein retention.

### SUMMARY

In one exemplary embodiment, a method is disclosed for processing Quinoa that includes soaking the seeds in an aqueous system having alkaline agents, and/or coating the seed with lipases, proteases and/or esterase enzyme preparation to reduce saponin content. After the Quinoa seed is ground, it is steeped in water that is treated with enzymes or a series of combinations of enzymes. The water is then heated further and sparged or rinsed with hot water. The resulting liquid wort is then separated from the washed grains for further processing and potential combination with other base liquids.

In other exemplary embodiments, Quinoa seed is processed, milled and is subject to pH adjustment. A separation process is performed to separate protein from starches (carbohydrates) and other material. The proteins and starches are further separated and concentrated to increase protein-to-carbohydrate ratios in the end food product. In an alternate embodiment, instead of further separating proteins and starches, the starches are hydrolyzed prior to concentration in order to improve protein-to-carbohydrate ratios in the end food product.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a medial longitudinal section of a Quinoa seed prior to processing;

FIG. 2 illustrates an exemplary process for preparing the seed of FIG. 1 to produce a food product;

FIG. 3 illustrates another exemplary process for processing the seed of FIG. 1 to produce a food product having improved protein-to-carbohydrate formulation;

FIG. 4 illustrates an alternate exemplary process for processing the seed of FIG. 1 to produce a food product having improved protein-to-carbohydrate formulation

FIG. 5 is a chart illustrating exemplary effects of milling time on protein content;

FIG. 6 is a chart illustrating exemplary effects of milling time on dry solid content; and

FIG. 7 is a chart illustrating exemplary effects of dry solid content on protein solution.

### DETAILED DESCRIPTION

The present invention is described herein with reference to one or more exemplary embodiments, however, it should be understood that the present invention is not limited to these embodiments. Those skilled in the art will appreciate that other arrangements, formulations and other elements can be used instead, and some elements may be omitted altogether.

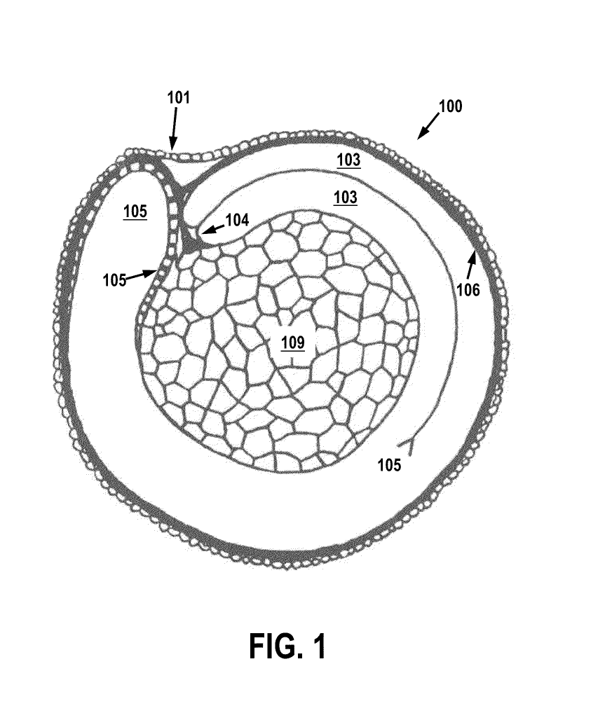

Turning to FIG. 1, the structure of a Quinoa seed 100 is illustrated prior to processing. The seed 100 is approximately 2.5 mm in length and 1.0 mm in diameter, and the weight of 1000 seeds can vary from 1.9 to 4.3 g. Quinoa seed is considered a fruit and its major anatomical parts include the outer covering which comprises the pericarp 101 and seed coat 106, the perisperm 109, and the embryo, which comprises the radicle 105 and cotelydons 103. Other parts of the Quinoa seed include the funicle 104, the endosperm 102 and shoot appendix 104. Unlike cereals, storage reserves for the developing Quinoa embryo (103, 105) are found in the perisperm 109 rather than in the endosperm 102. The embryo that surrounds the perisperm 109 is dicotyledonous and is part of the bran fraction of the seed; it is high in protein and lipid and contains most of the ash, fiber and saponins.

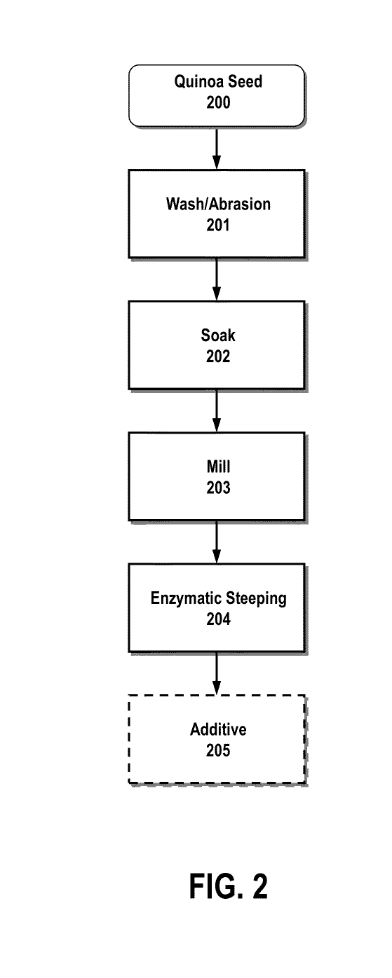

Turning to FIG. 2, the Quinoa seed 200 is preferably washed at the beginning of the processing 201 in order to remove saponins. Additionally, the seeds may undergo an abrasive dehulling (e.g., using a tangential abrasive dehulling device) to remove the outer layers of the seed. Depending on the saponin content, the abrasion should be configured to remove approximately 1-15% of the seed surface. Mechanical abrasion can also be used to increase α-amylase activity in Quinoa seed, due to the removal of the pericarp, which is relatively low in α-amylase. A combination of abrasive milling and washing may also be utilized. Some of the saponin-rich pericarp material would be physically removed, while the losses of nutrients concentrated in the hull would be minimized.

Next the seeds are soaked in an aqueous system with any of many alkaline agents to adjust the ph from 7.5 to 12.5. These agents include but are not limited to sodium hydroxide, potassium hydroxide, and sodium bicarbonate. When Quinoa seeds are soaked, it may be preferable to forego mechanical abrasion, as this process potentially removes desired nutrients. Alcohol washing can be used both alone or in conjunction with aqueous washing. Many potential combinations exist which have varying degrees of effectiveness. Typically ethanol would be used for the alcohol wash. Wash times can vary from a few minutes to up to 48 hours.

Another method which can be employed with the above techniques involves the treatment of seeds with lipases, proteases and/or esterase enzyme preparations to reduce to saponin coating. A lipase is a water-soluble enzyme that catalyzes the hydrolysis of ester bonds in water-insoluble, lipid substrates, and comprise a subclass of the esterases. A protease is any enzyme that conducts proteolysis, that is, begins protein catabolism by hydrolysis of the peptide bonds that link amino acids together in the polypeptide chain forming the protein. An esterase is a hydrolase enzyme that splits esters into an acid and an alcohol in a chemical reaction with water called hydrolysis. A wide range of different esterases exist that differ in their substrate specificity, their protein structure, and their biological function.

After enzymatic treatment, the processed seeds are subjected to a milling process 203, preferably a wet-milling process (e.g., using a Waring blender). The crushed grain is then steeped with water ranging from 1 to 10 times the weight of the grain. The mixture is then heated to 140-200° F. while being treated with enzymes 204 or a series of combination of enzymes. The enzymes can be α-amylases, pullulanases, β-amylases, proteases, or other combinations of food-grade enzymes. These enzymes can be from fungal, bacterial, or other sources. The enzyme-enriched steep water may benefit from the addition of calcium and sodium ions to improve the enzyme efficiency during the heat treatment. Flours or other protein enriched fractions can be added 205 during this process to improve the nutrition value of the food preparation.

The temperature of the mixture is then raised to over 190° F. to deactivate the enzyme activity 206. The grains are sparged (rinsed) 207 with hot water (120° F.-210° F.) to maximize the extraction efficiency. The liquid wort (liquor) is then separated from the washed grains for further processing.

From this a Quinoa milk-type beverage can be produced. Typically, this would be accomplished by blending the base liquid described above with other ingredients. This mixture would then be heated to accomplish pasteurization/sterilization, potentially homogenized, and packaged for sale. Many food products can be produced from the residual grains produced by this process such as chips, snacks, nutritional bars, fiber-rich functional foods and other products.

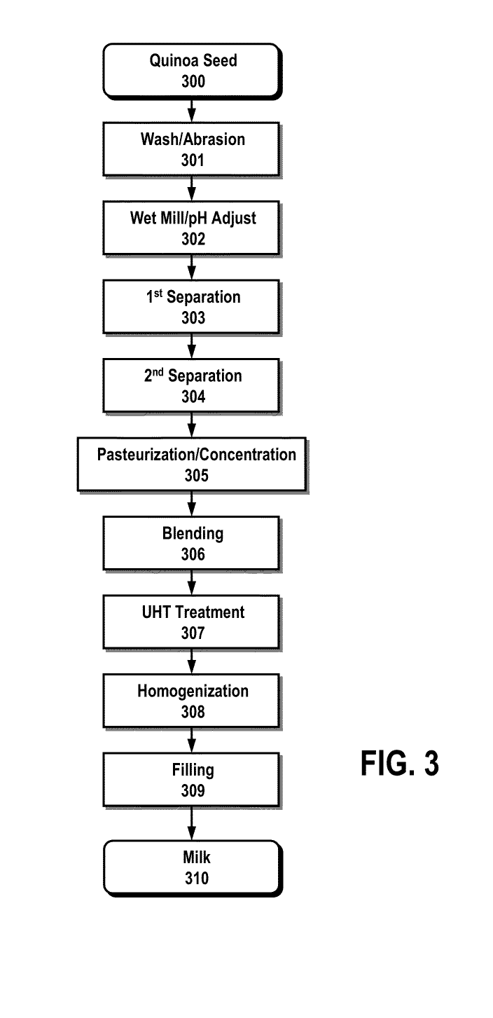

A second embodiment for an exemplary process for creating a milk analog is disclosed in FIG. 3. Here, batches of Quinoa seed 300 (or any other suitable proteinaceous material) are washed and/or subjected to an abrasion process 301, which may be similar to the process disclosed in FIG. 2. Under one embodiment, the seeds are subject to abrasive dehulling, where the abrasion should be configured to remove approximately 1-15% of the seed surface. The mechanical dehulling may also involve “pearling” the grain to remove the pericarp as bran. Alternately the grain can also be “pre-toasted” and “polished” or abraided using a spinning stone. As mentioned previously, abrasion tends to reduce ash content in Quinoa and has been demonstrated to increase α-amylase activity. Alternately, the saponin content of Quinoa can be effectively reduced by minimal abrasion in a Tangential Abrasive Dehulling Device (TADD). A combination of abrasive milling and washing may also be utilized. Some of the saponin-rich pericarp material would be physically removed, while the losses of nutrients concentrated in the hull would be minimized. If Quinoa seeds are soaked, it may be preferable to forego mechanical abrasion, as this process potentially removes desired nutrients.

Next the seeds subjected to a wet milling process in 302 where the Quinoa seed is reduced to slurry. Under a preferred embodiment, the wet milling is performed using a colloid mill, which is a machine that reduces the particle size of a solid in suspension in a liquid, or to reduce the droplet size of a liquid suspended in another liquid. The particle size reduction is performed by applying high levels of hydraulic shear to the process liquid. The colloid mill may also serve to increase the stability of suspensions and emulsions. Furthermore, in step 302, the slurry may be combined with alkaline agents to adjust the ph to a desirable level (e.g., from 7.5 to 12.5). These agents include but are not limited to sodium hydroxide, potassium hydroxide, and sodium bicarbonate. Alcohol washing can be used both alone or in conjunction with aqueous washing. Many potential combinations exist which have varying degrees of effectiveness. Typically ethanol would be used for the alcohol wash. Wash times can vary from a few minutes to up to 48 hours.

Step 303 introduces a first separation that is performed on the slurry, preferably using a decanter. During decantation, the mixture is separated to leave the precipitate (sediments) in the original container. Typically, a small amount of solution may be left in the container in order to prevent small amounts of precipitate from flowing with the solution out of the container. The decanted slurry should have starch, proteins and insolubles separated during the process in 303. In step 304, a second separation is performed, preferably using a centrifuge operating between 2500-3500 RPMs or higher for a predetermined period of time (30 sec.-5 mins) in order to further separate the starch and proteins. Steps 303-304 are advantageous for obtaining a proper protein-to-carbohydrate ratio. The liquid resulting from the decantation has a protein-to-carbohydrate ratio from 1:1.5 to 1:3. As further starch is removed in the centrifuge during step 304, the ratio becomes increased further still. The remaining starch is useful for providing body to the end milk product.

In step 305, the liquid is pasteurized by continuously heating it at a temperature of approximately 175-215 degrees Fahrenheit for a period of time of at least 20 seconds or longer in order to cure the mixture. After pasteurization, the liquid is then subjected to membrane filtration 305 in order to concentrate the protein in the resultant Quinoa water. One exemplary filtration technique includes nanofiltration (NF), which utilizes a membrane pore size of about 1 nanometer, with a molecular weight cut-off of 1000 daltons or less. Another exemplary filtering technique includes ultrafiltration (UF), which uses hydrostatic pressure to force liquid against a semipermeable membrane to retain suspended solids and solutes of high molecular weight, while passing water and low molecular weight solutes. Additionally, a concentration step is performed in 305 to concentrate the protein content of the Quinoa water. As the starch (carbohydrate) content is reduced during the separation steps 303-304 described above, the protein-to-carbohydrate ratios are largely unaffected after concentration step 305 is performed.

In step 306, the Quinoa water is blended to provide flavor(s), masking and/or whitening, if desired. Under one embodiment, the concentrated mixture may be blended with additional water, oil(s), salt, coloring/whitening agent(s) and sweetener(s). Suitable oils include vegetable oils, and particularly triglyceride oils, including palm, soybean, rapeseed, sunflower seed, peanut, cottonseed, palm kernel, coconut and olive oils. Other possible oils include corn, grape seed, hazelnut, linseed, rice bran, safflower and sesame oils. Under a preferred embodiment, when the concentrated mixture is to be used for a milk analog, titanium dioxide (TiO₂) (also known as “titanium(IV) oxide” or “titania”) may be used as a whitening agent to give the liquid a more “milk-like” appearance. Additional or alternate food coloring agents may be used as well. For sweetening, any suitable natural and/or artificial food sweetener may be used. Exemplary formulations for the blending process include 5-15% water, 0.25-2.5% oil, 0.02-0.07% salt, 0.1-0.5% coloring/whitening agent and 0.5%-1.5% sweetener.

In step 308, the blended mixture is subjected to ultra-high-temperature processing (UHT), where it is heated to temperatures exceeding 275° F. for a period of 1-3 seconds. Next, the mixture is homogenized 308 and filled 309 to produce resulting milk 310. Using the nanofiltration described in FIG. 3, UHT treatment and homogenization is typically performed during production. The formulation described above is particularly advantageous when using a range of 150-300 g/L of Quinoa seed for the resulting food product. The resulting protein content has been found to be between 3.5-5 g of protein per serving (236 g), with a 1.5-2.5 wt. % of protein.

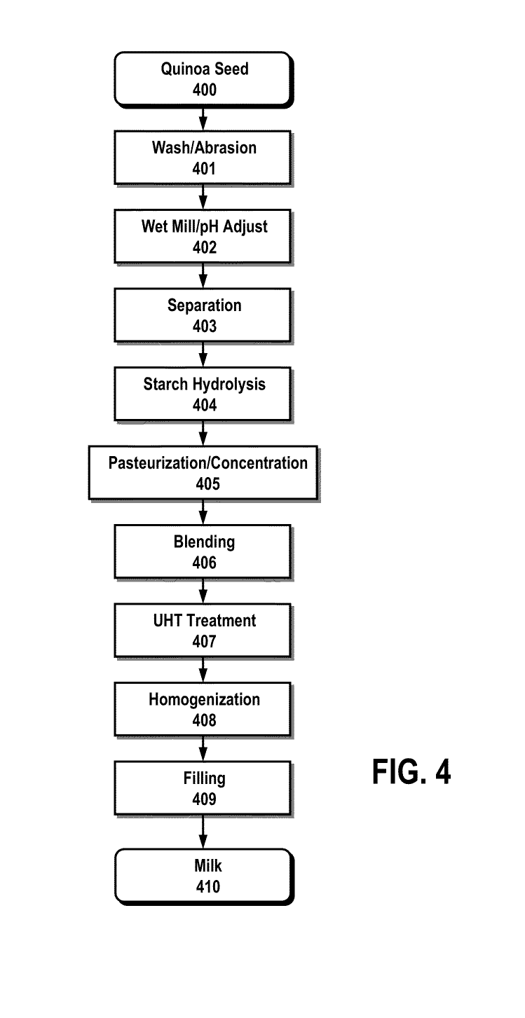

Turning to FIG. 4, an alternate embodiment is disclosed, where Quinoa seed 400 is subjected to wash/abrasion 401 and wet mill/pH adjustment 402, similar to the techniques described in 300-302 in connection with FIG. 3. In step 403, a separation is performed on the slurry, preferably using a decanter, where the mixture is separated to leave the sediments in the original container. The decanted slurry should have starch, proteins and insolubles separated during the process in 403. Next, instead of performing a second separation as illustrated in step 304 of FIG. 3, the starches in the mixture are hydrolyzed 404. Being a polysaccharide, starch is considered a carbohydrate consisting of a large number of glucose units joined together by glycosidic bonds. In order to break down or hydrolyze the starch into the constituent sugars, one or more enzymes (e.g., amylases) are added to break down the carbohydrates, ultimately yielding maltotriose and maltose from amylose, or maltose, glucose and “limit dextrin” from amylopectin. This process is preferably performed in a heated environment ranging from 40°-60° C. As the starch is broken down to glucose, this can further enhance the sweetness of the end product.

After the mixture is hydrolyzed, the process continues with pasteurization/concentration 405, blending 406, UHT treatment 407, homogenization 408 and filling 409 to produce the final milk product 410. The steps correspond to steps 305-310 disclosed above in connection with FIG. 3 and will not be repeated for the sake of brevity

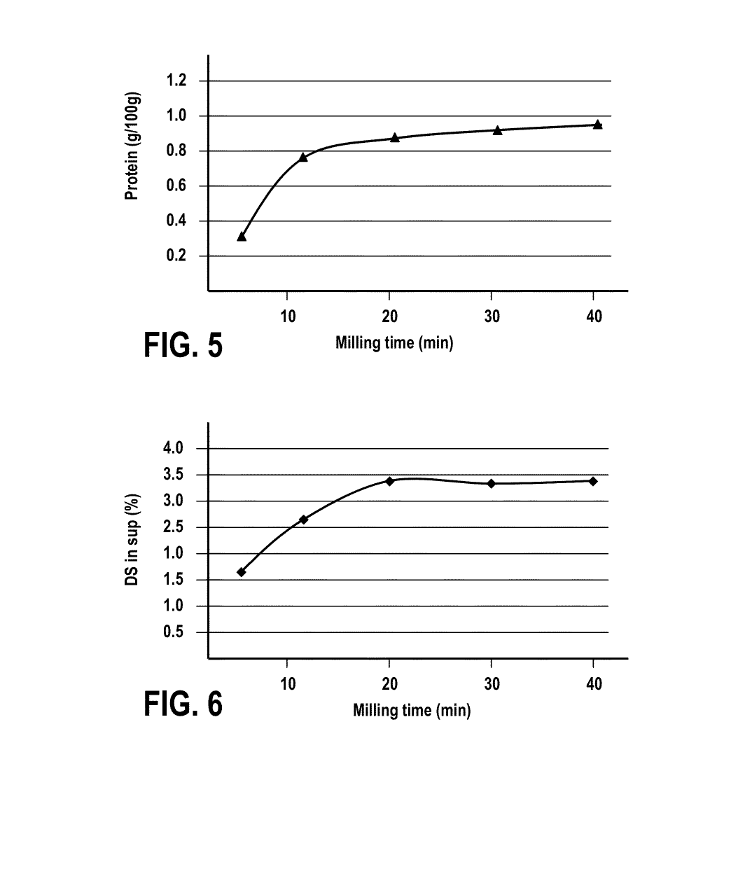

Turning to FIG. 5, an exemplary chart is provided for illustrating the effects of willing time on protein content under the present invention. As can be seen from the chart, protein content increases sharply when milling times range between 5-15 minutes, and increase more gradually thereafter. FIG. 6 illustrates the effect of milling time on dry solid content in the solution (DS in sup). The milling process can affect the nutritional content of the resulting food product, as there are pluralities of areas of food reserves in quinoa seeds that include a central perisperm, a peripheral embryo and the endosperm surrounding the hypocotyl-radicle axis of the embryo (see FIG. 1). Generally, starch grains occupy the cells of the perisperm, while lipid bodies, protein bodies with globoid crystals of phytin, and proplastids with deposits of phytoferritin are the storage components of the cells of the endosperm and embryo tissues. As can be seen from the chart in FIG. 6, the dry solid content increases at a greater rate between 5-25 minutes, and levels off thereafter. By retaining a certain amount of dry solids in the solution, the protein content of the resulting food product may be increased further. Depending on the milling process used, optimal milling times in FIG. 6 would range between 10 and 25 minutes.

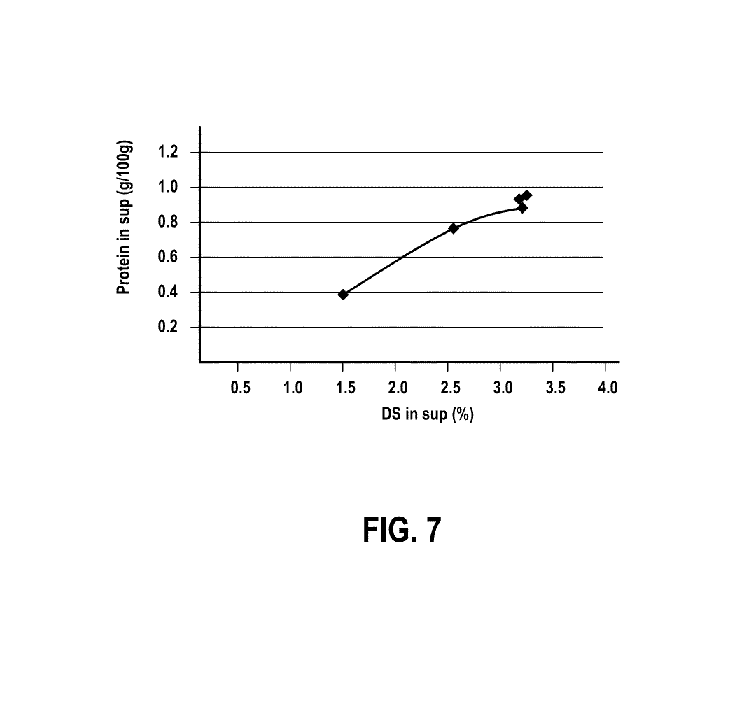

FIG. 7 provides an exemplary illustration of a relationship between the retained solids (DS in sup) and protein content in the solution from FIG. 6. As can be seen from FIG. 7, there is a substantially linear relationship between the dry solids and protein content, which levels off when the dry solid content approaches 3%. Of course, the type of milling and milling times also have an effect on the texture and “feel” of a food product, and extended milling can add to time and cost to production.

Although various embodiments of the present invention have been described with reference to a particular arrangement of parts, features and the like, these are not intended to exhaust all possible arrangements or features, and indeed many other embodiments, modifications and variations will be ascertainable to those of skill in the art.

What is claimed is:

1. A method for processing a food product comprising a proteinaceous material, comprising the steps of:
processing the proteinaceous material to separate proteins and carbohydrates;
processing the carbohydrates to establish a protein-to-carbohydrate ratio of at least 2:1.
